(19) United States
(12) Patent Application Publication
(10) Pub. No.: US 2026/0290983 A1
(43) Pub. Date: Sep. 24, 2026

(54) BATTERY MODULE AND MANUFACTURING METHOD THEREOF

(71) Applicant: LG ENERGY SOLUTION, LTD., Seoul (KR)

(72) Inventors: Taekyeong LEE, Daejeon (KR); Byeongyoon JUNG, Daejeon (KR); Sun Jung LEE, Daejeon (KR); Donghyun KIM, Daejeon (KR)

(73) Assignee: LG ENERGY SOLUTION, LTD., Seoul (KR)

(21) Appl. No.: 18/874,418

(22) PCT Filed: Jun. 13, 2023
(86) PCT No.: PCT/KR2023/008114

§ 371 Date: Dec. 12, 2024

(30) Foreign Application Priority Data
Jun. 14, 2022 (KR) 10-2022-0072093

(51) Int. Cl. H01M 50/291; H01M 50/211; H01M 50/271; H01M 50/367; H01M 50/507; H01M 50/51

(52) U.S. Cl. CPC H01M 50/291; H01M 50/211; H01M 50/271; H01M 50/367; H01M 50/507; H01M 50/51

(57) ABSTRACT

A battery module includes a housing having a hollow space therein; a plurality of busbars installed at one end portion and other end portion in a first direction of the hollow space; a plurality of battery cells disposed in the hollow space along a second direction intersecting the first direction and upward and downward directions, wherein each of the plurality of battery cells comprises: a body disposed at a center portion in the first direction of the hollow space; and a pair of electrodes and in contact with the plurality of busbars and protruding from the body toward one side and other side of the first direction; and one or more barriers extending in the first direction and the upward and downward directions.

### TECHNICAL FIELD

This application claims the benefit of priority based on Korean Patent Application No. 10-2022-0072093, dated Jun. 14, 2022, and entire contents disclosed in the documents of the patent applications are included as a part of this specification.

The present invention relates to a battery module and a manufacturing method of a battery module, and more particularly, to a battery module and a manufacturing method of a battery module in which heat transfer between battery cells is delayed or prevented and manufacturing costs are reduced.

### BACKGROUND ART

A secondary battery refers to a battery that may be charged and discharged, unlike primary batteries that cannot be recharged. These secondary batteries are used in small, high-tech electronic devices such as mobile phones, PDAs and laptop computers as well as in energy storage systems (ESS), electric vehicles (EV) or hybrid electric vehicles (HEV) as a power source.

A battery module refers to a device in which a plurality of secondary batteries (referred to as “battery cells” hereinafter) is connected in series or parallel. When a problem such as a short circuit occurs in some of the battery cells in the battery module and the temperature of the battery cell exceeds the critical temperature, a thermal runaway phenomenon may occur.

Heat and flame generated by the thermal runaway phenomenon of some battery cells in the battery module elevate the temperature of other battery cells, which can cause the thermal runaway phenomenon to spread to other battery cells. When the thermal runaway phenomenon rapidly spreads to other battery cells, the possibility of ignition or explosion of the battery module increases. Therefore, it is necessary to delay heat transfer between battery cells. In this regard, description will be given with reference to FIG. 1.

FIG. 1 is a plan view illustrating a conventional battery module.

Referring to FIG. 1, a conventional battery module 1 may include a housing 2, a busbar 3 and a battery cell 4. A plurality of battery cells 4 may be electrically connected to the busbar 3.

For example, when a thermal runaway phenomenon occurs in the battery cell 4 shown at the upper end of the drawing (one end of the second direction), heat, flame, etc. may be transferred/propagated, thereby propagating the thermal runaway phenomenon to the battery cell 4 adjacent to the battery cell 4 shown at the upper end of the drawing. Moreover, for example, heat, flame, etc. may be transferred/propagated through the busbar 3 or the space where the busbar 3 is installed, as shown by the dashed-dotted arrow A such that the thermal runaway phenomenon is propagated even to the battery cell that is not adjacent to the battery cell 4 shown at the upper end of the drawing.

Here, when the plurality of battery cells 4 in FIG. 1 are connected in series, the thermal runaway phenomenon can spread more rapidly to non-adjacent battery cells 4, and the possibility of the battery module igniting or exploding increases. In case the plurality of battery cells 4 connected in series, a pair of battery cells 4 that are not adjacent to each other have a larger potential difference than a pair of adjacent battery cells 4 such that the possibility of the problem of short circuit in the battery cell 4 increases due to the thermal runaway phenomenon spreading more rapidly to non-adjacent battery cells 4 having a large potential difference.

Therefore, in order to reduce the possibility of ignition or explosion of the battery module, not only the heat transfer between adjacent battery cells 4 but also the heat transfer between non-adjacent battery cells 4 must be delayed. Prior art related to delaying heat transfer between battery cells is as follows.

Korean Patent Application Publication No. 10-2022-0014117 discloses a battery module that includes an endothermic firewall capable of controlling the heat transfer phenomenon caused by a battery fire, wherein an endothermic firewall is interposed between a plurality of secondary battery cells accommodated in the battery module.

However, the prior art does not provide a method to delay heat transfer between non-adjacent battery cells 4.

### PRIOR ART DOCUMENT

### Patent Document

(Patent Document 0001) Korean Patent Application Publication No. 10-2022-0014117

### DISCLOSURE

### Technical Problem

In order to solve the above-described problems, it is an object of the present invention to provide a battery module in which heat transfer between battery cells is delayed or prevented.

It is an object of the present invention to provide a battery module capable of reducing the possibility of ignition or explosion of the battery module.

It is an object of the present invention to provide a battery module that delays or prevents heat transfer between battery cells while connecting the battery cells to one another electrically.

It is an object of the present invention to provide a battery module that is lightweight, reduces manufacturing and maintenance costs, and shortens manufacturing time.

Objects of the present invention are not limited to the above-described objects, and other objects and advantages of the present invention will be understood by the following description and will be more definitely understood through the embodiments of the present invention. It is also to be easily understood that the objectives and advantages of the present invention may be realized and attained by means and a combination thereof described in the appended claims.

### Technical Solution

In order to solve the above-described problems, the present invention provides a battery module including a housing, a plurality of busbars, a plurality of battery cells and one or more barriers.

The housing may be provided with a hollow space therein.

The plurality of busbars may be installed at a first end portion and a second end portion of the housing, the first end portion and the second end portion spaced from each other in the first direction.

The plurality of battery cells are arranged in the hollow space and stacked side by side in a second direction that intersects the first direction and upward and downward directions.

Each of the plurality of battery cells may include a body and a pair of electrodes.

The body may be disposed at a center portion in the first direction of the hollow space.

The pair of electrodes may protrude from the body.

The pair of electrodes may be in contact with the busbar.

The one or more barriers may extend in the first direction and the upward and downward directions.

The one or more barriers may be installed between the bodies of a pair of the battery cells arranged adjacent to each other to partition the hollow space S.

The one or more barriers may extend in the first direction to the first end portion or the second end portion in the first direction of the housing to partition the first end portion or the second end portion.

A pair of the plurality of busbars which are installed at a first side of the second direction and a second side of the second direction of each of the one or more barriers with the each of the one or more barriers therebetween may be physically separated in the second direction by the one or more barriers.

In one embodiment, the housing may include a base and a first sidewall or a second sidewall.

The base may be extended in the first direction and the second direction.

The first sidewall may extend from a first end of the base in the upward direction.

The second sidewall may extend from a second end of the base in the upward direction.

Each of the one or more barriers may extend to be in contact with the first sidewall or the second sidewall.

In one embodiment, the one or more barriers may include a first barrier or a second barrier.

The first barrier may extend to contact the first sidewall.

The first barrier may be at least partially separated from the second sidewall.

The second barrier may extend to contact the second sidewall.

The second barrier may be at least partially separated from the first sidewall.

The plurality of busbars may include a first side busbar and a second side busbar.

The first side busbar and the second side busbar may be installed: at a first side and a second side of the first barrier, respectively, adjacent to the first barrier with the first barrier therebetween while physically separated from each other; or at a first side and a second side of the second barrier, respectively, adjacent to the second barrier with the second barrier therebetween while physically separated from each other.

The plurality of battery cells may include a first side battery cell and a second side battery cell.

The first side battery cell and the second side battery cell may be disposed: at the first side and the second side of the first barrier, respectively, adjacent to the first barrier; or at the first side and the second side of the second barrier, respectively, adjacent to the second barrier.

The pair of electrodes and of the first side battery cell may be in contact with: the first side busbar; and one of the plurality of busbars installed between the first barrier and the second sidewall or installed between the second barrier and the first sidewall.

The pair of electrodes and of the second side battery cell may be in contact with: the second side busbar; and one of the plurality of busbars installed between the first barrier and the second sidewall or installed between the second barrier and the first sidewall.

Accordingly, the one side battery cell and the other side battery cell may be connected in series.

In one embodiment, the one or more barriers is a plurality of barriers.

The plurality of barriers may include one or more first barriers and one or more second barriers.

The one or more first barriers may extend to the first end portion of the housing to partition the first end portion.

The one or more second barriers may extend to the second end portion of the housing to partition the second end portion.

The one or more first barriers and the one or more second barriers may be alternately arranged along the second direction.

The busbar installed at each of a first side and a second side of the one or more first barriers may be physically separated from each other with the one or more first barriers therebetween.

The busbar installed at each of a first side and a second side of the one or more second barriers may be physically separated from each other with the one or more second barriers therebetween.

In one embodiment, the one or more barriers is a plurality of barriers.

The plurality of barriers may include one or more first barriers and one or more second barriers.

The one or more first barriers may extend to the first end portion to partition the first end portion.

The one or more second barriers may extend to the second end portion to partition the second end portion.

The one or more first barriers may not partition the second end portion.

The one or more second barriers may not partition the first end portion.

The one or more first barriers and the one or more second barriers are alternately arranged along the second direction.

In one embodiment, at least a portion of the plurality of busbars may be installed at a first side of the first direction of the one or more first barriers or at a second side of the first direction of the one or more second barriers.

In one embodiment, the housing may include a cover covering an upper portion of the hollow space.

The cover may be provided with one or more exhaust holes.

The one or more exhaust holes may penetrate the cover.

The one or more exhaust holes may exhaust flame, heat or gas generated from the battery cell installed in the hollow space to an outside of the housing.

In one embodiment, a plurality of the barriers may be provided.

The plurality of barriers may include one or more first barriers and one or more second barriers.

The one or more first barriers may extend to the first end portion to partition the first end portion.

The one or more second barriers may extend to the second end portion to partition the second end portion.

The one or more first barriers may not partition the second end portion.

The one or more second barriers may not partition the first end portion.

The one or more first barriers and the one or more second barriers are alternately arranged along the second direction.

The one or more exhaust holes are provided at an upper portion of a first side of the first direction of the one or more first barriers or an upper portion of a second side of the first direction of the one or more second barriers.

In addition, in order to solve the above-described problem, the present invention provides a manufacturing method of a battery module including a housing manufacturing step for manufacturing the housing.

In the housing manufacturing step, at least a portion of the housing and at least a portion of the one or more barriers may be integrally extruded.

In one embodiment, the housing may include a base, a third sidewall, and a fourth sidewall.

The base may be extended in the first direction and the second direction.

The sidewall may extend from the base in the upward direction.

The fourth sidewall may extend from the base in the upward direction.

The at least a portion of the one or more barriers may be coupled to at least a portion of the upper surface of the base.

In the housing manufacturing step, the base, the third sidewall and the fourth sidewall, and the one or more barriers may be integrally extruded.

### Advantageous Effects

According to embodiments of the present invention, the battery module 10 may include: a housing having a hollow space S therein; a plurality of busbars installed at one end portion and other end portion in a first direction of the hollow space S; a plurality of battery cells disposed in the hollow space S along a second direction intersecting the first direction and upward and downward directions, wherein each of the plurality of battery cells comprises: a body disposed at a center portion in the first direction of the hollow space S; and a pair of electrodes and in contact with the plurality of busbars and protruding from the body toward one side and other side of the first direction; and one or more barriers extending in the first direction and the upward and downward directions, wherein each of one or more barriers is: disposed between the body of a pair of battery cells adjacent to each other in the second direction to partition, in the second direction, the center portion in the first direction of the hollow space S; and extending to one end portion or other end portion in the first direction of the housing to partition, in the second direction, the one end portion or the other end portion in the first direction of the hollow space S. As a result, heat transfer between the center portion in the first direction inside the housing and the battery cell at one end portion or the other end portion of the housing may be delayed or prevented.

Accordingly, even when a problem such as a short circuit occurs in some battery cells resulting in a thermal runaway phenomenon, rapid spread of the thermal runaway phenomenon to other battery cells is prevented, thereby reducing the possibility of ignition or explosion of the battery module.

In particular, one end portion or the other end portion in the first direction of the inside the housing, in which heat transfer between the battery cells is inevitable due to the busbar connecting the plurality of battery cells, is partitioned by the barrier. Thus, the heat transfer between battery cells may be effectively delayed or prevented.

In addition, since it is partitioned by the barrier, rapid heat transfer between the non-adjacent battery cells in the second direction having a large electric potential difference therebetween occurring at the one end portion or the other end portion in the first direction of the inside the housing may be prevented. Therefore, the possibility of ignition or explosion of the battery module may be reduced.

According to embodiments of the present invention, the housing may include: a base extending in the first direction and the second direction; and a first sidewall extending in the upward direction from one end portion in the first direction of the base or a second sidewall extending in the upward direction from other end portion in the first direction of the base. Each of the one or more barriers may extend to the one side or the other side of the first direction to be in contact with the first sidewall or the second sidewall and accordingly partitions, in the second direction, the one end portion or the other end portion in the first direction of the hollow space S.

Accordingly, the housing and the barrier may be easily constructed with a simple configuration and at low cost.

According to embodiments of the present invention, the one or more barriers may include: a first barrier extending toward the one side of the first direction to be in contact with the first sidewall, partitioning, in the second direction, one end portion in the first direction of the hollow space S, and at least partially spaced apart from the second sidewall; or a second barrier extending toward the other side of the first direction to be in contact with the second sidewall, partitioning, in the second direction, the other end portion in the first direction of the hollow space S, and at least partially spaced apart from the first sidewall. The plurality of busbars may include one side busbar (also referred to as first side busbar) and other side busbar (also referred to as second side busbar). The one side busbar and the other side busbar may be installed: at one side and other side of the second direction of one side in the first direction of the first barrier, respectively, adjacent to the first barrier with the first barrier therebetween while physically separated from each other; or at the one side and the other side of the second direction of other side in the first direction of the second barrier, respectively, adjacent to the second barrier with the second barrier therebetween while physically separated from each other. The plurality of battery cells may include one side battery cell (also referred to as first side battery cell) and other side battery cell (also referred to as second side battery cell). The one side battery cell and the other side battery cell are disposed: at one side and other side in the second direction of the first barrier, respectively, adjacent to the first barrier; or at one side and other side in the second direction of the second barrier, respectively, adjacent to the second barrier. A pair of electrodes and of the one side battery cell may be in contact with: the one side busbar; and one of the plurality of busbars installed between the first barrier and the second sidewall or installed between the second barrier and the first sidewall. A pair of electrodes and of the other side battery cell are in contact with: the other side busbar; and one of the plurality of busbars installed between the first barrier and the second sidewall or installed between the second barrier and the first sidewall. Thus, the one side battery cell and the other side battery cell may be connected in series.

Accordingly, since the one side busbar and the other side busbar are physically separated from each other with the first barrier or second barrier therebetween, the one end portion or the other end portion in the first direction of the inside the housing is clearly partitioned by the first barrier or second barrier. Therefore, heat transfer between battery cells may be effectively delayed or prevented.

In addition, the electrode or at the other side in the first direction of the one side battery cell and the other side battery cell may be electrically connected to each other (in series) even when the electrode or at the one side in the first direction of the one side battery cell and the other side battery cell are not connected to each other due to the physical separation between the one side busbar and the other side busbar. That is, the one end portion or the other end portion in the first direction of the inside the housing is clearly partitioned by the first barrier or the second barrier while electrically connecting the one side battery cell and the other side battery cell.

According to embodiments of the present invention, a plurality of barriers may be provided. The plurality of barriers may include: one or more first barriers extending to the one end portion in the first direction of the housing to partition, in the second direction, the one end portion in the first direction of the hollow space S; and one or more second barriers extending to the other end portion in the first direction of the housing to partition the other end portion in the first direction of the hollow space S in the second direction. The one or more first barriers and the one or more second barriers are alternately arranged along the second direction. The busbar installed at each of one side and other side of the second direction of one side in the first direction of the one or more first barriers may be physically separated from each other with the one or more first barriers therebetween. The busbar installed at each of one side and other side of the second direction of other side in the first direction of the one or more second barriers is physically separated from each other with the one or more second barriers therebetween.

Accordingly, since the busbars are physically separated from each other with the first barrier and the second barrier therebetween, the one end portion and the other end portion in the first direction of the inside the housing are clearly partitioned by the first barrier and second barrier. Therefore, heat transfer between battery cells may be effectively delayed or prevented.

In addition, the electrodes at the other side may be electrically connected to each other (in series) through the busbar installed at the other side in the first direction of the first barrier or through the busbar installed at one side in the first direction of the second barrier even when one electrode at the one side in the first direction of the battery cells disposed at one side and the other side in the second direction of the first barrier and the second barrier are not connected to each other due to the physical separation between the busbars with the first barrier and the second barrier therebetween. That is, the one end portion and the other end portion in the first direction of the inside the housing are clearly partitioned by the first barrier and the second barrier while electrically connecting the battery cells.

According to embodiments of the present invention, a plurality of barriers may be provided. The plurality of barriers may include: one or more first barriers extending to the one end portion in the first direction of the housing to partition, in the second direction, the one end portion in the first direction of the hollow space S; and one or more second barriers extending to the other end portion in the first direction of the housing to partition the other end portion in the first direction of the hollow space S in the second direction. The one or more first barriers may not partition, in the second direction, the other end portion in the first direction of the hollow space S. The one or more second barriers do not partition, in the second direction, the one end portion in the first direction of the hollow space S. The one or more first barriers and the one or more second barriers are alternately arranged along the second direction.

Accordingly, the flame, heat or gas generated from the battery cell may transfer/propagate/spread through the one end portion or the other end portion in the first direction of the housing that is not partitioned by the first barrier and the second barrier in the second direction. Therefore, the possibility of ignition or explosion of the battery module 10 may be reduced.

In addition, since flame, heat or gas generated from the battery cell is able to reach the other battery cell only by repeatedly traveling back and forth between two end portions of the housing in the first direction, the transfer of flame, heat or gas between battery cells may be delayed. Therefore, the possibility of ignition or explosion of the battery module 10 may be reduced.

In addition, since the flame or heat generated from the battery cell sequentially propagates in the second direction to the adjacent battery cells having a small potential difference, the possibility of ignition or explosion of the battery module is reduced, and even when ignition or explosion occurs, damage may be reduced.

Additionally, since the lengths in the first direction of the first barrier and the second barrier are reduced, the battery module may be lightweight.

Additionally, a hollow space may be provided in which the busbar may be installed at the other side in the first direction of the first barrier and at one side in the first direction of the second barrier. Therefore, in order to perform insert installation or penetration installation of the busbar at the other side in the first direction of the first barrier and at one side in the first direction of the second barrier, it is not necessary to process the first barrier and the second barrier. Thus, the manufacturing cost of the battery module may be reduced and the manufacturing time may be shortened.

According to embodiments of the present invention, at least a portion of the plurality of busbars may be installed at the other side in the first direction of the first barrier or at one side in the first direction of the second barrier.

Accordingly, since the busbar may be easily installed and replaced, the manufacturing and maintenance costs of the battery module may be reduced.

According to embodiments of the present invention, the housing may include a cover that covers the upper portion of the hollow space S. The cover is provided with one or more exhaust holes penetrating the cover for exhausting flame, heat or gas generated from the battery cell installed in the hollow space S to an outside of the housing.

Accordingly, heat may be prevented from being accumulated or concentrated inside the housing, the amount of transferred heat may be reduced, and heat transfer may be delayed. Therefore, the possibility of ignition or explosion of the battery module may be reduced.

According to embodiments of the present invention, a plurality of barriers may be provided. The plurality of barriers may include: one or more first barriers extending to the one end portion in the first direction of the housing to partition, in the second direction, the one end portion in the first direction of the hollow space S; and one or more second barriers extending to the other end portion in the first direction of the housing to partition the other end portion in the first direction of the hollow space S in the second direction. The one or more first barriers may not partition, in the second direction, the other end portion in the first direction of the hollow space S. The one or more second barriers may not partition, in the second direction, the one end portion in the first direction of the hollow space S. The one or more first barriers and the one or more second barriers may be alternately arranged along the second direction. The one or more exhaust holes are provided at an upper portion of other side of the first direction of the one or more first barriers or an upper portion of one side of the first direction of the one or more second barriers.

Accordingly, since exhaust holes are provided in areas where the direction of transfer (propagation) of flame, heat or gas rapidly changes, flame, heat or gas is prevented from being accumulated or concentrated, and flame, and heat or gas may be effectively discharged to the outside of the housing even when the number or the size of exhaust holes are small. Therefore, the possibility of ignition or explosion of the battery module may be reduced.

According to embodiments of the present invention, the manufacturing method of a battery module may include a housing manufacturing step of manufacturing a housing. In the housing manufacturing step, at least a portion of the housing and at least a portion of the one or more barriers may be integrally extruded.

Accordingly, the manufacturing cost of the battery module may be reduced and the manufacturing time may be shortened.

According to embodiments of the present invention, the housing may include: a base extending in first and second directions; a third sidewall extending in an upward direction from one end portion in the second direction of the base; and a fourth sidewall extending in the upward direction from other end portion of the base. The at least a portion of the one or more barriers may be coupled to at least a portion of an upper surface of the base. At least a portion of the base, at least a portion of the third sidewall and at least a portion of the fourth sidewall, and the at least a portion of the one or more barriers may be integrally extruded in the housing manufacturing step.

Accordingly, the manufacturing cost of the battery module 10 may be reduced and the manufacturing time may be shortened.

In addition to the above-described effects, specific effects of the present invention will be described together with the following detailed description for implementing the present invention.

### DESCRIPTION OF DRAWINGS

FIG. 1 is a plan view illustrating a conventional battery module.

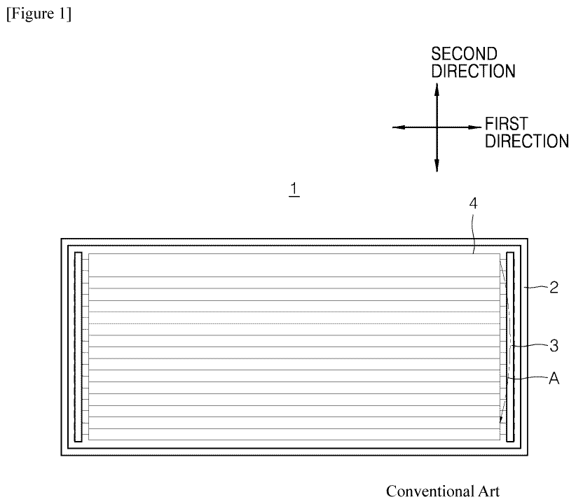

FIG. 2 is an exploded perspective view schematically illustrating a battery module according to an embodiment of the present invention.

FIG. 3 is a plan view of the battery module of FIG. 2 with the cover removed.

FIG. 4 is a diagram illustrating a state in which the battery cell in FIG. 3 has been removed.

FIG. 5 is a top view of the battery module of FIG. 2.

FIG. 6 is a side cross-sectional view of component C of FIG. 2.

FIG. 7 is a flowchart of a manufacturing method of a battery module according to an embodiment of the present invention.

### SPECIFIC DETAILS FOR CARRYING OUT THE INVENTION

The above objects, features and advantages will be described later in detail with reference to the accompanying drawings, and accordingly, those skilled in the art to which the present invention belongs will be able to easily implement the technical idea of the present invention. In describing the present invention, when it is determined that the detailed description of the known technology related to the present invention may unnecessarily obscure the subject matter of the present invention, the detailed description will be omitted. Hereinafter, preferred embodiments according to the present invention will be described in detail with reference to the accompanying drawings. In the drawings, the same reference numerals are used to indicate the same or similar components.

Although “first”, “second”, and the like may be used to describe various components, these components are not limited by these terms. These terms are only used to distinguish one component from another component, and unless otherwise stated, the first component may be the second component, of course.

Throughout the specification, unless otherwise stated, each component may be singular or plural.

Hereinafter, the arrangement of an arbitrary component on the “upper portion (or lower portion)” or “upper (or lower)” of a component means that an arbitrary component is placed in contact with the upper (or lower) surface of the component. In addition, it may mean that other components may be interposed between the component and any component disposed on (or under) the component.

In addition, when a component is described as “linked”, “coupled” or “connected” to another component, the components may be directly connected or connected to each other, but other components may be “interposed” between each component, or each component may be “linked”, “coupled” or “connected” through other components.

Singular expressions used herein include plural expressions unless the context clearly dictates otherwise. In this application, terms such as “consisting of” or “comprising” should not be construed as necessarily including all of the various components or steps described in the specification. It should be construed that it may not include some of the components or some of the steps or may further include additional components or steps.

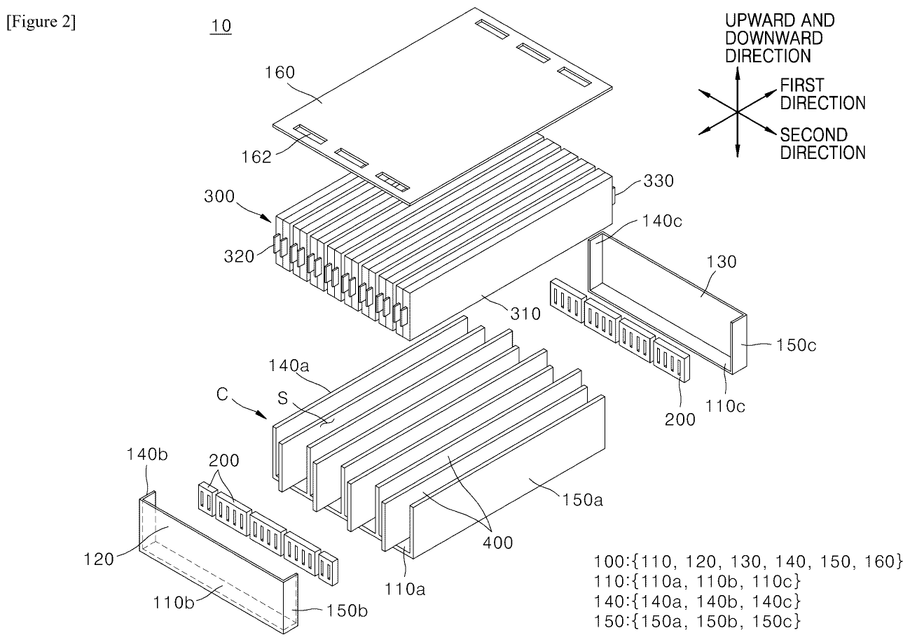

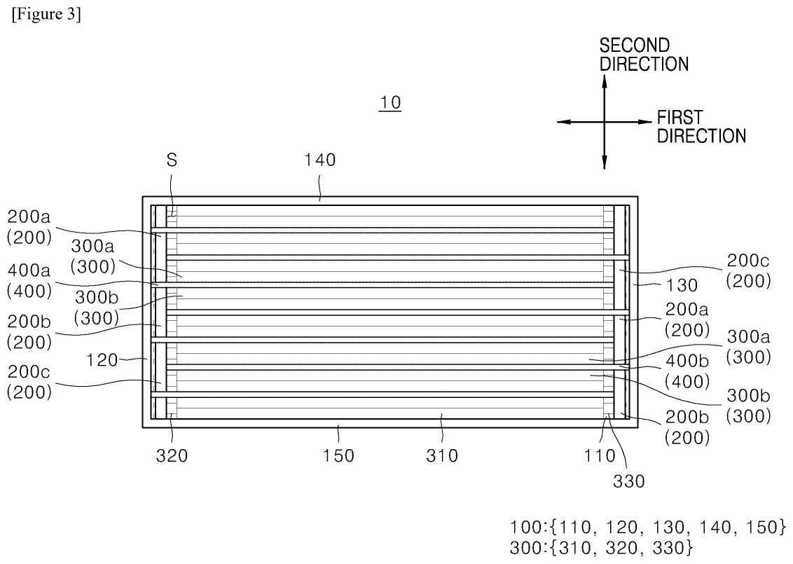

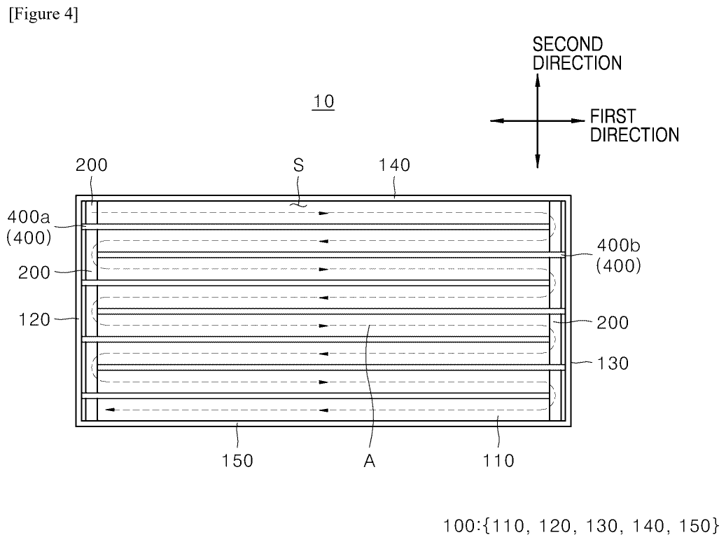

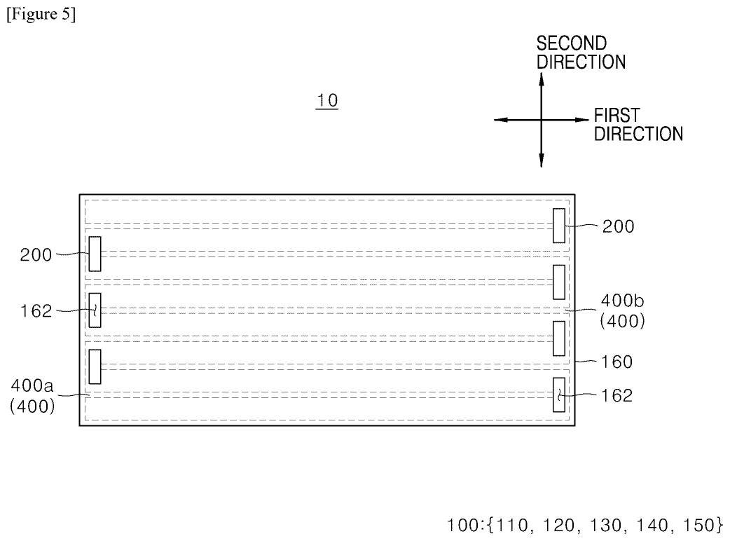

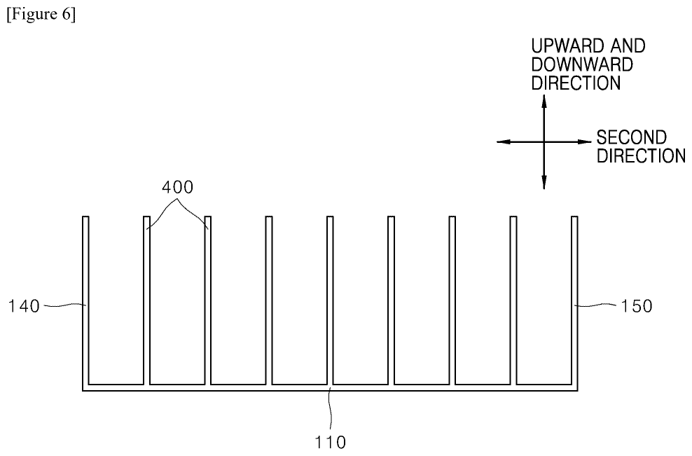

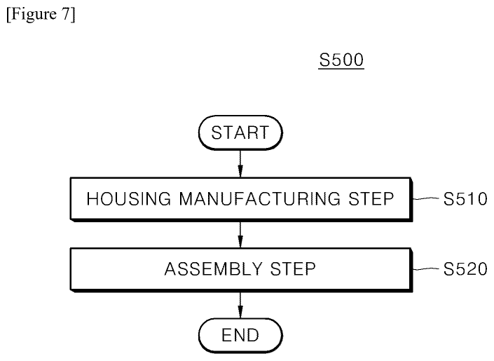

FIG. 2 is an exploded perspective view schematically illustrating a battery module according to an embodiment of the present invention. FIG. 3 is a plan view of the battery module of FIG. 2 with the cover removed. FIG. 4 is a diagram illustrating a state in which the battery cell in FIG. 3 has been removed. FIG. 5 is a top view of the battery module of FIG. 2. FIG. 6 is a side cross-sectional view of component C of FIG. 2. FIG. 7 is a flowchart of a manufacturing method of a battery module according to an embodiment of the present invention.

### [Battery Module]

Referring to FIGS. 2 to 6, the battery module 10 according to one embodiment may include a housing 100, a plurality of busbars 200, a plurality of battery cells 300, and one or more barriers 400. Each element will be described hereinafter.

### [Housing]

The housing 100 may be provided with a hollow space S therein.

The housing 100 may include a base 110 and a first sidewall 120 or a second sidewall 130. Additionally, the housing 100 may include a third sidewall 140 and a fourth sidewall 150. In addition, housing 100 may include a cover 160.

The base 110 may extend in the first direction (e.g., left and right directions) and the second direction (e.g., front and rear directions). The base 110 may have a plate shape.

The first sidewall 120 may extend from one end portion (left side end portion) in the first direction of the base 110 in upward direction. The first sidewall 120 may have a plate shape.

The second sidewall 130 may extend from other end portion (right side end portion) in the first direction of the base 110 in the upward direction. The second sidewall 130 may have a plate shape.

The third sidewall 140 may extend from one end portion in the second direction of the base 110 in the upward direction. The third sidewall 140 may have a plate shape.

The fourth sidewall 150 may extend from the other end portion in the second direction of the base 110 in the upward direction. The fourth sidewall 150 may have a plate shape.

The cover 160 may cover the upper portion of the hollow space S of the housing 100.

One or more exhaust holes 162 may be provided at the cover 160.

The one or more exhaust holes 162 may penetrate the cover 160. The one or more exhaust holes 162 may exhaust flame, heat or gas generated from the battery cell 300 installed in the hollow space S to an outside of the housing 100.

Accordingly, heat may be prevented from being accumulated or concentrated inside the housing 100, the amount of transferred heat may be reduced, and heat transfer may be delayed. Therefore, the possibility of ignition or explosion of the battery module 10 may be reduced.

### [Busbar]

A plurality of busbars 200 may be provided. The plurality of busbars 200 may be installed at one end portion and the other end portion in the first direction of the hollow space S of the housing 100.

The busbar may be provided with a hole through which the electrodes 320 and 330 of the battery cell 300 pass.

The plurality of busbars 200 may include one side busbar 200a and the other side busbar 200b (FIG. 3). The description thereof will be given later.

### [Battery Cell]

A plurality of battery cells 300 may be provided.

The battery cell 300 may include a body 310 and a pair of electrodes 320 and 330.

The body 310 may be disposed at a center portion in the first direction of the hollow space S. When the battery cell 300 is a pouch-type battery cell, the body 310 may be a portion wrapped with a pouch of a laminate having an electrode and a separator stacked therein.

A pair of electrodes 320 and 330 may protrude from the body 310 toward one side and the other side of the first direction. When the battery cell 300 is a pouch-type battery cell, the pair of electrodes 320 and 330 may be electrode tabs or electrode leads that protrude to the outside of the pouch.

The pair of electrodes 320 and 330 may be in contact with the plurality of busbars 200. For example, the electrodes 320 and 330 may penetrate the hole provided in the busbar 200 and then be bent and fused or welded to the busbar 200. However, it is not limited to this configuration.

The plurality of battery cells 300 may be placed in the hollow space S of the housing 100. The plurality of battery cells 300 may be arranged side by side in the second direction that intersects the first direction and upward and downward directions.

The plurality of battery cells 300 may be connected in series or parallel.

For example, as shown, eight banks of two battery cells 300 connected in parallel may be connected in series. However, it is not limited to this configuration.

In a bank connected in parallel, the electrodes 320 and 330 of the plurality of battery cells 300 may be installed in a manner that the same polarities are aligned in the second direction. Between a pair of banks connected in series, the electrodes 320 and 330 of the battery cell 300 may be installed in a manner that opposite polarities are aligned in the second direction.

The plurality of battery cells 300 may include one side battery cell 300a and the other side battery cell 300b (FIG. 3). The one side battery cell 300a and the other side battery cell 300b may be battery cells 300 that belong to a pair of banks adjacent to each other, are disposed adjacent to each other, and are connected in series. The description thereof will be given later.

### [Barrier]

One or more barriers 400 may be provided. The one or more barriers 400 may be extended in the first direction and upward and downward directions.

The lower end portion of the barrier 400 may be coupled to a portion of the upper surface of the base 110 of the housing 100 (FIGS. 2 and 6). The barrier 400 may be formed integrally with at least a portion of the housing 100 or may be formed separately. The description thereof will be given later.

Additionally, the barrier 400 may be in contact with the first sidewall 120, the second sidewall 130 and the cover 160 of the housing 100.

For example, the barrier 400 may be made of a material with excellent thermal insulation properties including aerogel, mica, superwool and glass fiber. However, it is not limited to these materials. As another example, the barrier 400 may be a heat absorbing sheet made of a material that rapidly absorbs heat through a dehydration reaction.

The barrier 400 is installed between the bodies 310 of a pair of battery cells 300 arranged adjacent to each other in the second direction to partition, in the second direction, the center portion in the first direction of the hollow space S of the housing 100.

In addition, the one or more barriers 400 may extend in the first direction to one end portion or other end portion in the first direction of the housing 100 to partition, in the second direction, the one end portion or the other end portion in the first direction of the hollow space S.

As a result, heat transfer (propagation) between the center portion in the first direction inside the housing 100 and the battery cell 300 at one end portion or the other end portion of the housing 100 may be delayed or prevented.

Accordingly, even when a problem such as a short circuit occurs in some battery cells 300 resulting in a thermal runaway phenomenon, rapid spread of the thermal runaway phenomenon to other battery cells 300 is prevented, thereby reducing the possibility of ignition or explosion of the battery module 10.

In particular, one end portion or the other end portion in the first direction of the inside the housing 100, in which as heat transfer between the battery cells 300 is inevitable due to the busbar 200 connecting the plurality of battery cells 300, is partitioned by the barrier 400. Thus, the heat transfer between battery cells 300 may be effectively delayed or prevented.

In addition, since it is partitioned by the barrier 400, rapid heat transfer between the non-adjacent battery cells 300 in the second direction having a large electric potential difference therebetween occurring at the one end portion or the other end portion in the first direction of the inside the housing 100 may be prevented. Therefore, the possibility of ignition or explosion of the battery module 10 may be reduced. Detail description thereof is as follows.

When a bank is constituted by count of n battery cells 300 (n is a natural number) arranged side by side in the second direction and connected in parallel (two in the drawing), and a plurality of the banks (eight in the drawing) are sequentially connected in series, a pair of non-adjacent battery cells 300 in the second direction have a potential difference that increases as the number of battery cells 300 or banks connected and arranged between the pair of battery cells 300 increases. As the potential difference increases, the possibility of problems such as short circuits occurring in the battery cell 300 increases such that the thermal runaway phenomenon may rapidly spread to the battery cell 300 with a large potential difference resulting in significant increase in the probability of the ignition or explosion of the battery module 10. Therefore, when rapid heat transfer between battery cells 300 is prevented by partitioning one end portion or the other end portion in the first direction of the inside the housing 100 with the barrier 400, the possibility of ignition and explosion may be reduced.

For example, one or more barriers 400 may extend to one side or the other side in the first direction, respectively, and may contact the first sidewall 120 or the second sidewall 130 of the housing 100. Accordingly, one or more barriers 400 may partition, in the second direction, one end portion or the other end portion in the first direction of the hollow space S of the housing 100.

Accordingly, the housing 100 and barrier 400 may be easily constructed with a simple configuration and at low cost.

The one or more barrier 400 may include the first barrier 400a or the second barrier 400b.

The first barrier 400a may extend toward the one side of the first direction to be in contact with the first sidewall 120. Accordingly, the first barrier 400a may partition, in the second direction, one end portion in the first direction of the hollow space S of the housing 100.

The first barrier 400a may be at least partially spaced apart from the second sidewall 130.

The second barrier 400b extends to the other side in the first direction and can contact the second sidewall 130 of the housing 100. Accordingly, the second barrier 400b may partition, in the second direction, the other end portion in the first direction of the hollow space S of the housing 100.

The second barrier 400b may be at least partially spaced apart from the first sidewall 120.

Here, the above-described one side busbar 200a and the other side busbar 200b may be installed: at one side and other side of the second direction of one side in the first direction of the first barrier 400a, respectively, adjacent to the first barrier 400a with the first barrier 400a therebetween while physically separated from each other; or at the one side and the other side of the second direction of other side in the first direction of the second barrier 400b, respectively, adjacent to the second barrier 400b with the second barrier 400b therebetween while physically separated from each other.

In addition, the above-described one side battery cell 300a and the other side battery cell 300b may be disposed: at one side and other side in the second direction of the first barrier 400a, respectively, adjacent to the first barrier 400a; or at one side and other side in the second direction of the second barrier 400b, respectively, adjacent to the second barrier 400b.

The pair of electrodes 320 and 330 of the one side battery cell 300a may be in contact with: the one side busbar 200a; and one of the plurality of busbars 200 installed between the first barrier 400a and the second sidewall 130 or installed between the second barrier 400b and the first sidewall 120.

The pair of electrodes 320 and 330 of the other side battery cell 300b may be in contact with: the other side busbar 200b; and one of the plurality of busbars 200 installed between the first barrier 400a and the second sidewall 130 or installed between the second barrier 400b and the first sidewall 120.

Here, the space between the first barrier 400a and the second sidewall 130 may be defined by a space where the first barrier 400a is at least partially spaced apart from the second sidewall 130. Additionally, the space between the second barrier 400b and the first sidewall 120 may be defined by a space where the second barrier 400b is at least partially spaced apart from the first sidewall 120.

Thus, one side battery cell 300a and the other side battery cell 300b may be connected to each other in series.

Accordingly, since the one side busbar 200a and the other side busbar 200b are physically separated from each other with the first barrier 400a or second barrier 400b therebetween, the one end portion or the other end portion in the first direction of the inside the housing 100 is clearly partitioned by the first barrier 400a or second barrier 400b. Therefore, heat transfer between battery cells 300 may be effectively delayed or prevented.

In addition, the electrode 330 or 320 at the other side in the first direction of the one side battery cell 300a and the other side battery cell 300b may be electrically connected to each other (in series) even when the electrode 330 or 320 at the one side in the first direction of the one side battery cell 300a and the other side battery cell 300b are not connected to each other due to the physical separation between the one side busbar 200a and the other side busbar 200b. That is, the one end portion or the other end portion in the first direction of the inside the housing 100 is clearly partitioned by the first barrier 400a or the second barrier 400b while electrically connecting the one side battery cell 300a and the other side battery cell 300b.

Meanwhile, in contrast to the drawing, the one side busbar 200a and the other side busbar 200b may not be physically separated. For example, the one side busbar 200a and the other side busbar 200b may be connected to each other while penetrating the first barrier 400a or the second barrier 400b.

A plurality of barriers 400 may be provided.

The plurality of barriers 400 may include one or more first barriers 400a and one or more second barriers 400b.

The one or more first barriers 400a may extend to the one end portion in the first direction of the housing 100 such that one end portion in the first direction of the hollow space S of housing 100 is partitioned in the second direction.

The one or more second barriers 400b may extend to the other end portion in the first direction of the housing 100 such that the other end portion in the first direction of the hollow space S of housing 100 is partitioned in the second direction.

The first barrier 400a and the second barrier 400b may be alternately arranged along the second direction.

The busbars 200 installed at one side and the other side in first direction of one side in the second direction of the first barrier 400a, respectively, may be physically separated from each other with the first barrier 400a therebetween. For example, as described above, the one side busbars 200a and the other side busbar 200b installed adjacent to the first barrier 400a at one side and the other side in first direction of the one side in the second direction of the first barrier 400a, respectively, may be physically separated from each other with the first barrier 400a therebetween.

The busbars 200 installed at one side and the other side in first direction of the other side in the second direction of the second barrier 400b, respectively, may be physically separated from each other with the second barrier 400b therebetween. For example, as described above, the one side busbars 200a and the other side busbar 200b installed adjacent to the second barrier 400b at one side and the other side in first direction of the other side in the second direction of the second barrier 400b, respectively, may be physically separated from each other with the second barrier 400b therebetween.

Accordingly, since the busbars 200 are physically separated from each other with the first barrier 400a and the second barrier 400b there between, the one end portion and the other end portion in the first direction of the inside the housing 100 are clearly partitioned by the first barrier 400a and second barrier 400b. Therefore, heat transfer between battery cells 300 may be effectively delayed or prevented.

In addition, the electrodes at the other side may be electrically connected to each other (in series) through the busbar 200c installed at the other side in the first direction of the first barrier 400a or through the busbar 200c installed at one side in the first direction of the second barrier 400b even when one electrode at the one side in the first direction of the battery cells 300 disposed at one side and the other side in the second direction of the first barrier 400a and the second barrier 400b are not connected to each other due to the physical separation between the busbars 200 with the first barrier 400a and the second barrier 400b therebetween. That is, the one end portion and the other end portion in the first direction of the inside the housing 100 is clearly partitioned by the first barrier 400a and the second barrier 400b while electrically connecting the battery cells 300.

Meanwhile, in contrast to the drawing, the busbars 200 may not be physically separated from each other with the first barrier 400a or the second barrier 400b therebetween. For example, the busbars 200 may be connected to each other while penetrating the first barrier 400a or the second barrier 400b.

The one or more first barriers 400a may not partition, in the second direction, the other end portion in the first direction of the hollow space S of the housing 100. In addition, the one or more second barriers 400b may not partition, in the second direction, the one end portion in the first direction of the hollow space S of thee housing 100.

Therefore, for example, when a flame, heat or gas is generated in the battery cell 300 placed at one side of the second direction, the flame, heat or gas may reach other battery cells 300 by repeatedly traveling back and forth between two end portions of the housing 100 in the first direction as indicated by dotted arrow A of FIG. 4.

Accordingly, the flame, heat or gas generated from the battery cell 300 may transfer/propagate/spread through the one end portion or the other end portion in the first direction of the housing 100 that is not partitioned by the first barrier 400a and the second barrier 400b in the second direction. Therefore, the possibility of ignition or explosion of the battery module 10 may be reduced.

In addition, since flame, heat or gas generated from the battery cell 300 is able to reach the other battery cell 300 only by repeatedly traveling back and forth between two end portions of the housing 100 in the first direction, the transfer of flame, heat or gas between battery cells 300 may be delayed. Therefore, the possibility of ignition or explosion of the battery module 10 may be reduced.

In addition, since the flame or heat generated from the battery cell 300 sequentially propagates in the second direction to the adjacent battery cells 300 having a small potential difference, the possibility of ignition or explosion of the battery module 10 is reduced, and even when ignition or explosion occurs, damage may be reduced.

Additionally, since the lengths in the first direction of the first barrier 400a and the second barrier 400b are reduced, the battery module 10 may be lightweight.

Additionally, a hollow space may be provided in which the busbar 200 may be installed at the other side in the first direction of the first barrier 400a and at one side in the first direction of the second barrier 400b. Therefore, in order to perform insert installation or penetration installation of the busbar 200 at the other side in the first direction of the first barrier 400a and at one side in the first direction of the second barrier 400b, it is nor necessary to process the first barrier 400a and the second barrier 400b. Thus, the manufacturing cost of the battery module 10 may be reduced and the manufacturing time may be shortened.

Here, at least a portion of the plurality of busbars 200 may be installed at the other side in the first direction of the first barrier 400a or at one side in the first direction of the second barrier 400b.

Accordingly, since the busbar 200 may be easily installed and replaced, the manufacturing and maintenance costs of the battery module 10 may be reduced.

In addition, the one or more exhaust holes 162 may be provided at an upper portion of other side of the first direction of the one or more first barriers 400a or an upper portion of one side of the first direction of the one or more second barriers 400b (FIG. 5). Here, the other side in the first direction of the first barrier 400a and one side in the first direction of the second barrier 400b are where transfer (propagation) direction of flame, heat or gas changes rapidly as indicated by the dotted arrow A in FIG. 4.

Accordingly, since exhaust holes 162 are provided in areas where the direction of transfer (propagation) of flame, heat or gas rapidly changes, flame, heat or gas is prevented from being accumulated or concentrated, and flame, and heat or gas may be effectively discharged to the outside of the housing 100 even when the number or the size of exhaust holes 162 are small. Therefore, the possibility of ignition or explosion of the battery module 10 may be reduced.

Meanwhile, in contrast to the drawings, the first barriers 400a may extend in the first direction to the other end portion in the first direction of the housing 100 to partition, in the second direction, the other end portion in the first direction of the hollow space S. Here, the busbar 200 may be installed to penetrate the other side in the first direction of the first barrier 400a.

In addition, in contrast to the drawings, the second barrier 400b may extend in the first direction to the one end portion in the first direction of the housing 100 to partition, in the second direction, the one end portion in the first direction of the hollow space S. Here, the busbar 200 may be installed to penetrate the one side in the first direction of the first barrier 400a.

### [Manufacturing Method of Battery Module]

Referring to FIG. 7, the manufacturing method of a battery module S500 according to one embodiment may include a housing manufacturing step S510 and an assembly step S520.

In the housing manufacturing step S510, the housing 100 may be manufactured. The housing 100 may be extruded rather than formed using a press processing method.

Here, at least a portion of the barriers 400 among the one or more barriers 400 may be extruded integrally with at least a portion of the housing 100.

Accordingly, the manufacturing cost of the battery module 10 may be reduced and the manufacturing time may be shortened.

Specifically, for example, among the housing 100, at least portion 110a of the base 110, a portion 140a of the third sidewall 140 and a portion 150b of the fourth sidewall 150, and at least a portion of the one or more barriers 400 may be extruded integrally (component C of FIG. 2 and FIG. 6).

Accordingly, the manufacturing cost of the battery module 10 may be reduced and the manufacturing time may be shortened.

After integrally extruding at least a portion of the housing 100 and the at least a portion of the one or more barriers 400, both ends may be cut in the first direction such that the plurality of barriers 400 are alternately protrudes toward both sides of the first direction, as component C shown in FIG. 2.

However, it is not limited to this configuration. That is, in the housing manufacturing step S510, the barrier 400 may not be manufactured integrally with at least a portion of the housing 100.

In the assembly step S520, the busbar 200 may be installed inside the housing 100 and the battery cell 300 may be placed. The electrodes 320 and 330 of the battery cell 300 and the busbar 200 may be coupled in advance.

Meanwhile, when the barrier 400 is not manufactured integrally with at least a portion of the housing 100, the barrier 400 manufactured separately from the housing 100 may be attached to the housing 100 before placing the battery cell 300 and installing the busbar 200 in the assembly step S520.

It should be understood that the described embodiments are illustrative in all respects and not restrictive, and the scope of the present invention will be indicated by the following claims rather than the described detailed description. And the meaning and scope of the claims to be described later, as well as all changes and modifications derived from the equivalent concept should be interpreted as being included in the scope of the present invention.

Although the present invention has been described with reference to the exemplified drawings, it is to be understood that the present invention is not limited to the embodiments and drawings disclosed in this specification, and those skilled in the art will appreciate that various modifications are possible without departing from the scope and idea of the present invention. Further, although the operating effects according to the configuration of the present invention are not explicitly described while describing an embodiment of the present invention, it should be appreciated that predictable effects are also to be recognized by the configuration.

[DESCRIPTION OF REFERENCE NUMERALS]

| | |
|---|---|
| 10: battery module | |
| 100: housing | |
| 110: base | 120: first sidewall |
| 130: second sidewall | 140: third sidewall |
| 150: fourth sidewall | 160: cover |
| 162: exhaust hole | |
| 200: busbar | |
| 300: battery cell | 310: body |
| 320, 330: electrode | |
| 400: barrier | |

1. A battery module comprising:
a housing having a hollow space therein;
a plurality of busbars installed at a first end portion and a second end portion of the housing, the first end portion and the second end portion spaced from each other in a first direction;
a plurality of battery cells disposed in the hollow space and stacked along a second direction intersecting the first direction and upward and downward directions, wherein each of the plurality of battery cells comprises:
a body; and
a pair of electrodes in contact with the plurality of busbars and protruding from the body; and
one or more barriers extending in the first direction and the upward and downward directions, wherein each of one or more barriers is disposed between the body of a pair of battery cells adjacent to each other to partition the hollow space and extending to the first end portion or the second end portion of the housing to partition the first end portion or the second end portion,
wherein a pair of the plurality of busbars installed at a first side of the second direction and a second side of the second direction of each of the one or more barriers with the each of the one or more barriers therebetween are physically separated in the second direction by the one or more barriers.

2. The battery module of claim 1, wherein the housing comprises:
a base extending in the first direction and the second direction; and
a first sidewall extending in the upward direction from the first end portion and a second sidewall extending in the upward direction from the second end portion, and
wherein each of the one or more barriers extends to the one first sidewall or the second sidewall to be in contact with the first sidewall or the second sidewall.

3. The battery module of claim 2, wherein the one or more barriers comprises:
a first barrier extending toward the first sidewall to be in contact with the first sidewall, and at least partially spaced apart from the second sidewall; or
a second barrier extending toward the second sidewall to be in contact with the second sidewall, and at least partially spaced apart from the first sidewall,
wherein the plurality of busbars comprises a first side busbar and a second side busbar, wherein the first side busbar and the second side busbar are installed: at a first side and a second side of the first barrier, respectively, adjacent to the first barrier with the first barrier therebetween while physically separated from each other; or at a first side and a second side of the second barrier, respectively, adjacent to the second barrier with the second barrier therebetween while physically separated from each other,
wherein the plurality of battery cells comprises a first side battery cell and a second side battery cell, wherein the first side battery cell and the second side battery cell are disposed: at the first side and the second side of the first barrier, respectively, adjacent to the first barrier; or at the first side and the second side of the second barrier, respectively, adjacent to the second barrier,
wherein the pair of electrodes of the first side battery cell are in contact with: the first side busbar; and one of the plurality of busbars installed between the first barrier and the second sidewall or installed between the second barrier and the first sidewall,
wherein the pair of electrodes of the second side battery cell are in contact with: the second side busbar; and one of the plurality of busbars installed between the first barrier and the second sidewall or installed between the second barrier and the first sidewall, and
wherein the first side battery cell and the second side battery cell are connected in series.

4. The battery module of claim 1, wherein the one or more barriers is a plurality of barriers,
wherein the plurality of barriers comprises:
one or more first barriers extending to the first end portion of the housing to partition the first end portion; and
one or more second barriers extending to the second end portion of the housing to partition the second end portion,
wherein the one or more first barriers and the one or more second barriers are alternately arranged along the second direction,
wherein the busbar installed at each of a first side and a second side of the one or more first barriers is physically separated from each other with the one or more first barriers therebetween, and
wherein the busbar installed at each of a first side and a second side of the one or more second barriers is physically separated from each other with the one or more second barriers therebetween.

5. The battery module of claim 1, wherein the one or more barriers is a plurality of barriers,
wherein the plurality of barriers comprises:
one or more first barriers extending to the first end portion to partition the first end portion; and
one or more second barriers extending to the second end portion to partition the second end portion,
wherein the one or more first barriers do not extend to the second end portion,
wherein the one or more second barriers do not extend to the first end portion, and
wherein the one or more first barriers and the one or more second barriers are alternately arranged along the second direction.

6. The battery module of claim 5, wherein at least a portion of the plurality of busbars are installed at a first side of the first direction of the one or more first barriers or at a second side of the first direction of the one or more second barriers.

7. The battery module of claim 1, wherein the housing comprises a cover covering an upper portion of the hollow space, wherein the cover is provided with one or more exhaust holes penetrating the cover for exhausting flame, heat or gas generated from the battery cell installed in the hollow space to an outside of the housing.

8. The battery module of claim 7, wherein the one or more barriers is a plurality of barriers,
wherein the plurality of barriers comprises:
one or more first barriers extending to the first end portion to partition, the first end portion; and
one or more second barriers extending to the second end portion to partition the second end portion,
wherein the one or more first barriers do not extend to the second end portion,
wherein the one or more second barriers do not extend to the first end portion,
wherein the one or more first barriers and the one or more second barriers are alternately arranged along the second direction, and
the one or more exhaust holes are provided at an upper portion of a first side of the first direction of the one or more first barriers or an upper portion of a second side of the first direction of the one or more second barriers.

9. A manufacturing method of a battery module of claim 1, the manufacturing method comprising:
a housing manufacturing step of manufacturing a housing,
wherein at least a portion of the housing and at least a portion of the one or more barriers are integrally extruded in the housing manufacturing step.

10. The manufacturing method of claim 9, wherein the housing comprises:
a base extending in the first direction and the second directions;
a third sidewall extending in the upward direction from the base; and
a fourth sidewall extending in the upward direction from the base,
wherein the one or more barriers are coupled to an upper surface of the base, and
wherein the base, the third sidewall the fourth sidewall, and the one or more barriers are integrally extruded in the housing manufacturing step.
